(19) United States
(12) Patent Application Publication
(10) Pub. No.: US 2026/0139969 A1
(43) Pub. Date: May 21, 2026

(54) METHOD FOR TRAINING A CLASSIFIER FOR MAP VERIFICATION AND METHOD FOR MAP VERIFICATION

(71) Applicant: Robert Bosch GmbH, Stuttgart (DE)

(72) Inventors: Jan Rohde, Dettingen Unter Teck (DE); Max Kirstein, Hohenhameln - Ot Bruendeln, (DE); Peter Engel, Hessisch Oldendorf (DE); Thomas Wenzel, Hamburg (DE)

(21) Appl. No.: 19/375,934

(22) Filed: Oct. 31, 2025

(30) Foreign Application Priority Data
Nov. 18, 2024 (DE) 10 2024 211 024.8

(51) Int. Cl. G01C 21/00

(52) U.S. Cl. CPC G01C 21/387; G01C 21/3807; G01C 21/3833

(57) ABSTRACT

A method for training a classifier for map verification. A plurality of surroundings data sets, each of which represents respective surroundings of motor vehicles during respective trips of the motor vehicles through the same geographic region, are used to create a digital map of the geographic region, wherein in particular information or data resulting from the mapping pipeline are used to train the classifier or for map verification. A method for map verification, a device, a computer program, and a machine-readable storage medium are also described.

### CROSS REFERENCE

The present application claims the benefit under 35 U.S.C. § 119 of Germany Patent Application No. DE 10 2024 211 024.8 filed on Nov. 18, 2024, which is expressly incorporated herein by reference in its entirety.

### FIELD

The present invention relates to a method for training a classifier for map verification, a method for map verification, a device, a computer program, and a machine-readable storage medium.

### BACKGROUND INFORMATION

A digital road map can be generated on the basis of measurement data that are aggregated in different layers and together form an (HD) map, for instance. It can be assumed, for example, that the measurement data are already combined during acquisition and made available in a compacted representation; for instance, only lane markings in vehicle-relative coordinates instead of the original camera images. Errors can occur during map creation and lead to an incorrect depiction of reality. There is a need to prevent or identify such depiction errors in order to rectify them.

### SUMMARY

An object of the present invention is to provide training of a classifier for map verification.

The object of the present invention is also to provide map verification.

These objects may be achieved by certain features of the present invention. Advantageous embodiments of the present invention are disclosed herein.

According to a first aspect of the present invention, a method for training a classifier for map verification is provided. According to an example embodiment of the present invention, the method includes the following steps:
receiving a plurality of surroundings data sets, each of which represents respective surroundings of motor vehicles during respective trips of the motor vehicles through the same geographic region,
creating a digital map of the geographic region based on the surroundings data sets,
dividing the digital map into a plurality of map sections,
ascertaining input features for the plurality of map sections based on the received surroundings data sets, wherein the input features represent additional information for the plurality of map sections,
ascertaining a training data set comprising a plurality of training data points based on the input features, wherein the training data points each include a pair consisting of a feature tensor assigned to a position of the digital map and a ground truth label which is a measure of the correctness of a map section of the plurality of map sections comprising the corresponding position,
training the classifier based on the ascertained training data set to obtain a trained classifier, wherein a training step of training the classifier includes the classifier ascertaining, for a training data point, a measure of the correctness of the map section comprising the training data point based on the feature tensor of the training data point, wherein the ascertained measure is compared to the ground truth label of the training data point.

According to a second aspect of the present invention, a method for map verification is provided. According to an example embodiment of the present invention, the method includes the following steps:
receiving a plurality of surroundings data sets, each of which represents respective surroundings of motor vehicles during respective trips of the motor vehicles through the same geographic region,
creating a digital map of the geographic region based on the surroundings data sets,
dividing the digital map into a plurality of map sections,
ascertaining input features for the plurality of map sections based on the received surroundings data sets, wherein the input features represent additional information for the plurality of map sections,
ascertaining a feature tensor assigned to a position of the digital map based on the input features,
ascertaining one or more measures for the correctness of the map section of the digital map comprising the corresponding position based on the feature tensor by means of a classifier to verify the digital map.

According to a third aspect of the present invention, a device is provided, which is configured to carry out all steps of the method according to the first aspect of the present invention and/or according to the second aspect of the present invention.

According to a fourth aspect of the present invention, a computer program is provided, which comprises instructions that, when the computer program is executed by a computer, for example by the device according to the third aspect of the present invention and/or cause said computer to carry out a method according to the first aspect of the present invention and/or according to the second aspect of the present invention.

According to a fifth aspect of the present invention, a machine-readable storage medium is provided, on which the computer program according to the fourth aspect of the present invention is stored.

The present invention is based on and includes the insight that that the above object is achieved by ascertaining input features for a plurality of map sections of the digital map, wherein these input features represent additional information for the plurality of map sections. This additional information is used to train the classifier for map verification or for map verification of the digital map.

The training or the map verification can therefore be carried out efficiently without the need to provide a manual check, for example. There is in particular no need to use additional data beyond this additional information.

Thus, in particular information or data resulting from the mapping pipeline are used to train the classifier or for map verification. The input features are ascertained based on the created digital map, for instance. This means that the input features are, for example, ascertained indirectly based on the surroundings data sets. The input features are, for example, created directly based on the surroundings data sets.

In other words, it can, for example, be provided that an input feature is ascertained based on the digital map, i.e., indirectly based on the surroundings data sets. For example, it can be provided that an input feature is ascertained based directly on the surroundings data sets, i.e., ascertained based directly on the surroundings data sets.

The present invention described here can thus advantageously supplement a conventional digital map-generating system with a methodology that predicts the correctness of map sections or specific features of the map, for example lane markings, roadway geometry, using features, the input features, extracted from the mapping system. This can in particular be carried out without the addition of other data sources such as separate video images. The prediction is carried out by the classifier, which can be trained according to the concept described here. This simplifies and improves the quality assurance of the digital map through an improved correction process.

In one example embodiment of the method according to the first aspect of the present invention, it is provided that the respective feature tensor of the training data points is ascertained based on the input features assigned to the respective position.

This, for example, produces a technical advantage that the respective feature tensor can be ascertained efficiently.

In one example embodiment of the method according to the first aspect of the present invention, it is provided that the input features assigned to the respective position are each transformed into a fixed-length tensor to obtain the feature tensor.

This, for example, produces the technical advantage that the feature tensor can be obtained efficiently.

In one example embodiment of the method according to the first aspect of the present invention, it is provided that the respective ground truth label is ascertained based on a comparison of the corresponding map section with a ground truth map of the geographic region.

This, for example, produces the technical advantage that the respective ground truth label can be ascertained efficiently.

In one example embodiment of the method according to the first aspect of the present invention, it is provided that a completeness measure is ascertained for each corresponding map section based on the corresponding map section and the ground truth map, wherein the completeness measure is a measure of the completeness of the map contents of the map section relative to the ground truth map, wherein the respective ground truth label is ascertained based on the respective completeness measure.

This, for example, produces the technical advantage that the respective ground truth label can be ascertained efficiently.

In one example embodiment of the method according to the first aspect of the present invention, it is provided that a respective deviation from one or more positions of one or more map contents of the map section relative to the ground truth map is ascertained for the corresponding map section, wherein the respective ground truth label is ascertained based on the ascertained respective deviation or deviations.

This, for example, produces the technical advantage that the respective ground truth label can be ascertained efficiently.

In one example embodiment of the method according to the first aspect of the present invention, it is provided that a respective Jaccard index between one or more map contents of the map section relative to the ground truth map is ascertained for the corresponding map section, wherein the respective ground truth label is ascertained based on the respective ascertained Jaccard index.

This, for example, produces the technical advantage that the respective ground truth label can be ascertained efficiently.

The Jaccard Index, which can also be referred to as the Jaccard coefficient, is a statistic used to measure the similarity between sets. By its definition, it can also be referred to as IoU, which stands for “intersection over union”.

In one example embodiment of the method according to the first aspect of the present invention, it is provided that the input features are respective elements selected from the following group of input features: a landmark of the digital map, an additional attribute for a map feature of the digital map, a number of surroundings data sets used to ascertain the digital map at a location in the geographic region, metadata, in particular a source of a surroundings data set, an error measure which indicates a consistency of the digital map compared to the surroundings data sets used to create the digital map.

This, for example, produces the technical advantage that particularly suitable input features can be used.

An error measure is a chi-square error of an optimization of a plurality of observations or acquisitions, for example. An error measure is the number of outliers (unusual observations) in the creation process, for example.

In one example embodiment of the method according to the first aspect of the present invention, it is provided that the landmark is an element selected from the following group of landmarks: lane marking, traffic light system, traffic sign, upright structure.

This, for example, produces the technical advantage that particularly suitable landmarks can be provided.

A surroundings data set comprises a surroundings model, for instance, and/or surroundings sensor raw data and/or evaluated surroundings sensor raw data and/or landmark(s).

A surroundings sensor is a surroundings sensor of the corresponding motor vehicle, for example.

A surroundings data set was created based on an acquisition of a surroundings of a motor vehicle by one or more surroundings sensors of the motor vehicle, for example. Thus, for instance, a landmark was acquired by one or more surroundings sensors of the motor vehicle, so that corresponding evaluation of the surroundings sensor raw data identified the landmark in the surroundings of the motor vehicle, so that the surroundings data set comprises this information.

In one embodiment of the method according to the first aspect of the present invention, it is provided that the additional attribute indicates what information is provided by the traffic sign, or the additional attribute indicates a type of lane marking.

This, for example, produces the technical advantage that particularly suitable additional attributes can be used.

In one example embodiment of the method according to the first aspect of the present invention, it is provided that the metadata, in particular the metadata of a source of a surroundings data set, comprise one or more of the following pieces of information: a type of motor vehicle, a motor vehicle speed, the surroundings sensor modality and/or surroundings sensor version of a surroundings sensor of the corresponding motor vehicle used to create the corresponding surroundings data set, a date of acquisition of the corresponding surroundings by one or more surroundings sensors of the corresponding motor vehicle used to create the corresponding surroundings data set, a time of acquisition of the corresponding surroundings by one or more surroundings sensors of the corresponding motor vehicle used to create the corresponding surroundings data set, the weather at the time of acquisition of the corresponding surroundings by one or more surroundings sensors of the corresponding motor vehicle used to create the corresponding surroundings data set, a type, in particular city or freeway, information about the surroundings, in particular a number of motor vehicles and/or pedestrians and/or bicyclists and/or road users.

This, for example, produces the technical advantage that particularly suitable metadata can be used.

In one example embodiment of the method according to the first aspect of the present invention, it is provided that the ground truth label and/or the measure of correctness ascertained by means of the classifier indicates a respective class affiliation in terms of correctness to two or more classes.

Correctness includes a plurality of different aspects, for example. A measure of correctness can therefore indicate which one or which of these aspects are correct and in particular which are not. For instance, a class can be complete (one aspect), but there may be a positional inaccuracy (another aspect), for example, and/or lane markings (another aspect), in particular lines, may be missing.

This, for example, produces the technical advantage that a particularly suitable ground truth label or a particularly suitable classifier can be provided.

In one example embodiment of the method according to the second aspect of the present invention, it is provided that a confidence of the corresponding map section is ascertained as a measure, wherein the confidence is compared to a threshold value, wherein, depending on the comparison, a binary truth value is ascertained as a measure which indicates whether the corresponding map section is correct or incorrect.

This, for example, produces the technical advantage that a particularly suitable measure is ascertained.

In one example embodiment of the method according to the second aspect of the present invention, it is provided that a variance of a confidence of the corresponding map section is ascertained as a measure.

This, for example, produces the technical advantage that a particularly suitable measure is ascertained.

In one example embodiment of the method according to the second aspect of the present invention, it is provided that the classifier has been or is being trained according to the method according to the first aspect.

This, for example, produces the technical advantage that a particularly suitable classifier is used for the method according to the second aspect of the present invention.

Features of the method according to the first aspect of the present invention emerge analogously from features of the method according to the second aspect of the present invention and vice versa. Statements made in connection with the method according to the first aspect of the present invention apply analogously to embodiments of the method according to the second aspect of the present invention and vice versa.

For example, the method according to the second aspect of the present invention comprises one or more steps of the method according to the first aspect of the present invention and vice versa.

The method according to the first aspect of the present invention is a computer-implemented method, for instance.

The method according to the second aspect of the present invention is a computer-implemented method, for instance.

The device is configured in terms of programming to execute the computer program, for example.

The embodiments and embodiment examples of the present invention described here can be combined with one another in any way, even if this is not explicitly described.

A tensor within the meaning of the description is a vector, for example, or includes a vector, for example.

The present invention is explained in more detail in the following with reference to preferred embodiment examples.

### BRIEF DESCRIPTION OF THE DRAWINGS

FIG. 1 shows a flow chart of a method for training a classifier for map verification, according to an example embodiment of the present invention.

FIG. 2 shows a flow chart of a method for map verification, according to an example embodiment of the present invention.

FIG. 3 shows a device according to an example embodiment of the present invention.

FIG. 4 shows a machine-readable storage medium according to an example embodiment of the present invention.

FIG. 5 shows a block diagram according to an example embodiment of the present invention.

### DETAILED DESCRIPTION OF EXAMPLE EMBODIMENTS

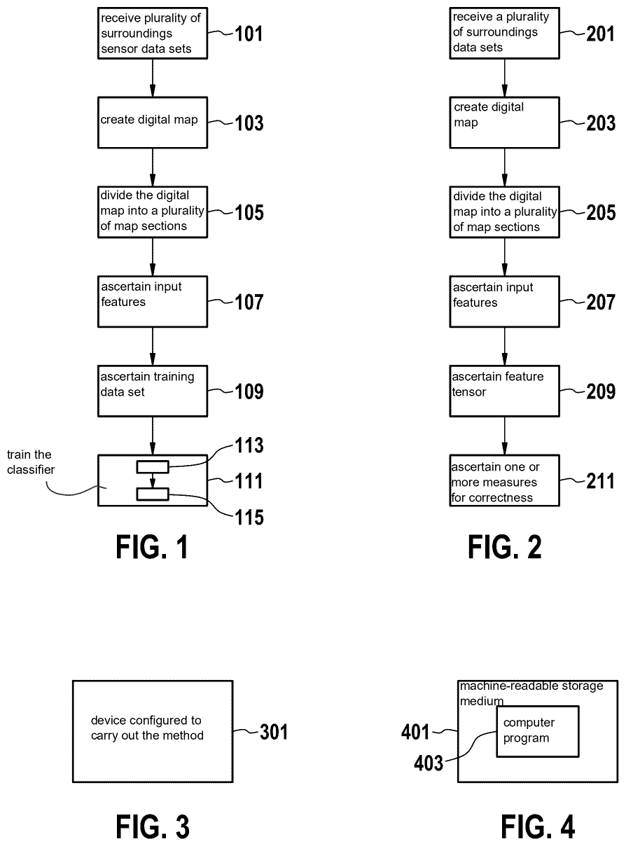

FIG. 1 shows a flow chart of a method for training a classifier for map verification, comprising the following steps: receiving 101 a plurality of surroundings data sets, each of which represents respective surroundings of motor vehicles during respective trips of the motor vehicles through the same geographic region,
creating 103 a digital map of the geographic region based on the surroundings data sets,
dividing 105 the digital map into a plurality of map sections,
ascertaining 107 input features for the plurality of map sections based on the received surroundings data sets, wherein the input features represent additional information for the plurality of map sections,
ascertaining 109 a training data set comprising a plurality of training data points based on the input features, wherein the training data points each include a pair consisting of a feature tensor assigned to a position of the digital map and a ground truth label which is a measure of the correctness of a map section of the plurality of map sections comprising the corresponding position,
training 111 the classifier based on the ascertained training data set to obtain a trained classifier, wherein a training step of training the classifier includes the classifier ascertaining 113, for a training data point, a measure of the correctness of the map section comprising the training data point based on the feature tensor of the training data point, wherein the ascertained measure is compared 115 to the ground truth label of the training data point.

An epoch of training includes N such training steps, for instance, wherein N is dependent on the size of the training data set. For example, N=number of samples/batch size. Multiple samples, i.e. training data points, are aggregated for a training data set, for example to a fixed batch size, and only one weight update is carried out for the entire batch, for example.

FIG. 2 shows a flow chart of a method for map verification, comprising the following steps:
receiving 201 a plurality of surroundings data sets, each of which represents respective surroundings of motor vehicles during respective trips of the motor vehicles through the same geographic region,
creating 203 a digital map of the geographic region based on the surroundings data sets,
dividing 205 the digital map into a plurality of map sections,
ascertaining 207 input features for the plurality of map sections based on the received surroundings data sets, wherein the input features represent additional information for the plurality of map sections,
ascertaining 209 a feature tensor assigned to a position of the digital map based on the input features,
ascertaining 211 one or more measures for the correctness of the map section of the digital map comprising the corresponding position based on the feature tensor by means of a classifier to verify the digital map.

FIG. 3 shows a device 301, which is configured to carry out all steps of the method according to the first aspect and/or according to the second aspect.

The device 301 includes a communication device, for example, which is configured to receive the plurality of surroundings data sets via a communication network.

The device 301 includes a processor device, for example, which is configured to carry out the further steps of the method according to the first aspect and/or according to the second aspect, for example steps 103 to 115 and/or steps 203 to 211.

The processor device comprises one or more processors, for example,.

The device 301 is implemented in a cloud infrastructure, for instance.

FIG. 4 shows a machine-readable storage medium 401, on which a computer program 403 is stored. The computer program 403 comprises instructions that, when the computer program 403 is executed by a computer, for example by the device 301 of FIG. 3, cause said computer to carry out a method according to the first aspect and/or according to the second aspect.

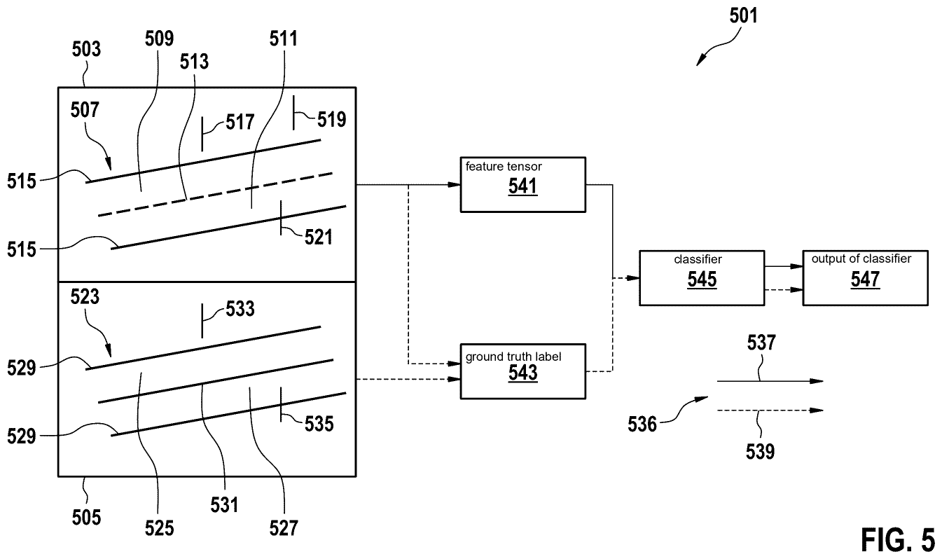

FIG. 5 shows a block diagram 501 which explains the here-described concept or the here-described concepts using an example.

The reference sign 503 indicates a map section of a digital map within the meaning of the description. The reference sign 505 indicates a reference map section of a ground truth map within the meaning of the description that corresponds to the map section 503.

The map section 503 represents a road 507 comprising two travel lanes 509, 511 which are separated from one another by a dashed centerline 513. The road 507 is laterally delimited by lane boundary lines 515.

The map section 503 also represents elements, characterized by the reference signs 517, 519, 521, which can symbolize a vertical structure, i.e. an upright structure, a traffic light system or a traffic sign, for example.

The reference map section 505 represents a road 523 comprising two travel lanes 525, 527, which are separated from one another by a solid centerline with the reference sign 531. Lane boundary lines with the reference sign 529 delimit the road 523 laterally.

Elements with the reference signs 533, 535 are shown as well and are represented by the reference map section 505. These elements can be a vertical, i.e. upright, structure, a traffic light system or a traffic sign, for example.

The figure shows a legend with the reference sign 536, which includes a solid arrow with the reference sign 537 and a dashed arrow with the reference sign 539.

The solid arrow with the reference sign 537 indicates the flow of the block diagram 501 in an embodiment of a method according to the second aspect, i.e. during inference. The dashed arrow with the reference sign 539 indicates a flow of the block diagram 501 in an embodiment of the method according to the first aspect, i.e. during training.

The here-described concept or the here-described concepts in particular provide training a classifier for map verification. Training the classifier requires training data which are ascertained according to the concept described here. A data point of the training data set, i.e. a training data point, consists in particular of a pair (X, y).

X here describes a generic data vector or tensor, the feature tensor within the meaning of the description, and y describes an associated ground truth label within the meaning of the description. y describes a class affiliation, for example, i.e. the correctness of the corresponding map section. y can thus be defined, for example, as follows: y∈{0, 1}.

In the block diagram 501, X is identified as a block with the reference sign 541 and y is identified as a block with the reference sign 543.

To ascertain the feature tensor, the surroundings data sets based on which the digital map was created, from which the map section 503 originated, are used directly or indirectly.

Input features can thus be information from the created digital map itself, for example, for instance metadata, or intermediate results from the mapping pipeline, for example. Such input features include one or more of the following features or pieces of information, for example:
map features (landmarks) such as lane markings or geometry, traffic lights, traffic signs, upright structures such as poles/trees,
additional attributes of the map features, such as not only information about the existence of a traffic sign at a position, but also the specific speed limit or the type of lane marking (solid or dashed),
redundancy in the form of the number of raw data sets that were used for the map position at a location (e.g. number of passes),
metadata of the source, e.g. vehicle type, speed, sensor modality and version, date of acquisition,
error measures that measure the consistency of the generated map compared to the raw data used; i.e. error measures that arose in the mapping pipeline.

The above input features are transformed into a feature vector or feature tensor of fixed length, X, for example. Scalars can be adopted directly here as an entry into a vector component or tensor component, for example. Positions of features can be converted into a vector or tensor by applying a fixed grid and then unrolling, for instance. A normalization of value ranges of the input features, for example, is provided. Methods analogous to those used in point cloud registration, for instance, can be used here. Ground truth labels can be ascertained by comparing the generated map sections with a reference map, the so-called ground truth map, for example, and/or for instance by manual annotations. A ground truth map can be generated using measurement fleets specifically provided for this purpose, for example, and data such as video images can be used as well or instead. The decisive factor here is the resulting correct depiction of reality and the assignment of each to-be-evaluated map section to a ground truth label, for example to a ground truth label y∈{0, 1}. For example, the following can be used: completeness of map contents, deviation of the position of individual map contents, Jaccard index between map features in the reference map and the generated or created digital map.

Thus, X and y are ascertained or generated as described above. A training data set is then in particular compiled such that feature tensors and corresponding ground truth labels are ascertained or generated for a sufficiently large number of map positions in order to advantageously cover a data distribution of the expected application data.

(Deep) neural networks or support vector machines (SVMs) can be used for the training, for example, and can, for instance, be trained with standard loss functions, such as cross-entropy. The training data set created or ascertained within the framework of the here-described concept can be divided into a training part and a validation part, for instance.

After the classifier, identified in the block diagram 501 by a block with the reference sign 545, has been trained, it can be used for the method for map verification. The classifier 545 can thus be used to make predictions at new data points. For these new data points, it is ensured that the features X can be obtained from the mapping system. After the classifier 545 has been trained, it can therefore advantageously be used to evaluate the mapping results, i.e. the comparison results. For this purpose, the classification, the input data X of which, i.e. the input features, are processed in the same way as when constructing the training data set, is carried out at the end of the mapping pipeline, for example. Of course, ground truth labels are not required for this.

One or more measures of correctness are ascertained as the output of the map verification process. In the block diagram 501, an output of the classifier, i.e., the measure or measures, is identified by a block with the reference sign 547.

The following can therefore be provided as the output:
a confidence c normalized to [0, 1],
a binary truth value ascertained by applying a threshold value to c,
in an advantageous configuration, further measures of the uncertainty or variance of c using standard methods from the literature, such as ensemble creation.

In summary, the classifier predicts whether the digital (HD) map matches a reference at a given location or whether there is an error. This involves only considering maps with a level of detail that is higher than that of navigation maps, for example; for instance through the existence of landmarks or lane-accurate information. A special advantage here arises in particular from the data used and the intended application of the above classifier in the context of evaluating created maps and with the objective of enabling a more reliable overall system using maps. The here-described concept or the here-described concepts thus enhance an existing digital map-generating system with the methodology that allows the correctness of map sections or specific features of the map (e.g. lane markings, roadway geometry, . . . ) to be predicted based on features extracted from the mapping system. This is in particular possible without the addition of other data sources such as separate video images. This predication is carried out by a classifier. This makes it possible to simplify and/or improve the quality assurance of the map through an improved correction process.

According to the here-described concepts, in particular the use of specific features from the mapping pipeline or metadata from the underlying raw data, the input features, is provided.

The (machine learning) classifier, for instance, is trained. For this purpose, the features, i.e. the input features, being used include the contents of the created digital map, for example, and the associated features extracted from the mapping system. A statement about the correctness of a map section (binary label), which has been ascertained by manual labeling and/or automated comparison with a ground truth map previously created in subregions of the world, for instance, is used as the ground truth, for example. A classifier (e.g. neural network, SVM) can then be trained on the data set created in this way.

When the classifier is applied, for example, generalization is carried out on the entire map via locations with training data availability. The classifier predicts the correctness of map excerpts or individual map layers or included landmarks for map sections. The features of the examined map sections are transformed, for example analogously to the training, into feature vectors, the feature tensors or feature vectors. The result is a binary prediction ascertained by applying a threshold value (e.g. 0.5), for example, or the underlying “confidence” between 0 and 1.

The advantage of the here-described concepts is in particular that the correctness of a generated map or partial content can be checked and evaluated with significantly reduced (manual) effort and without the need to use additional data. Map portions identified as incorrect can be excluded from use or corrected (e.g. through human review) or proposed for expanded/renewed data collection. The confidence can moreover be stored in the map content to enable improved decision-making for the functions accessing it.

The result of the classification can be used to evaluate the quality of the generated map. It can be used, for example,
in a downstream function that can use the confidence to decide whether the map quality is sufficient,
for example, to reduce the manual effort of map verification and correction (through direct use or as an indicator in a manual review),
for example, to evaluate and improve the mapping pipeline through improved automatic analysis of error cases or the detection of incorrect input data,
for example, to evaluate sufficient input data in the mapping pipeline and, if necessary, to selectively acquire additional data (improved quality or extent) for regions with insufficient input data.

The here-described concepts in particular provide the application of the principle of binary classification. This problem category deals with data in which each data point can be assigned to exactly one of two possible classes. The two classes in this context are specified by the correctness or incorrectness of the map in a section. The objective of binary classification is then in particular to use machine learning methods to learn a classification rule that assigns each data point to one of the two classes.

The present invention relates to a method for training a classifier for map verification. A plurality of surroundings data sets, each of which represents respective surroundings of motor vehicles during respective trips of the motor vehicles through the same geographic region, are used to create a digital map of the geographic region, wherein in particular information or data resulting from the mapping pipeline are used to train the classifier or for map verification.

The present invention relates to a method for map verification, a device, a computer program and a machine-readable storage medium.

What is claimed is:

1. A method for training a classifier for map verification, comprising the following steps:
receiving a plurality of surroundings data sets, each of the surroundings data sets representing respective surroundings of motor vehicles during respective trips of the motor vehicles through the same geographic region;
creating a digital map of the geographic region based on the surroundings data sets;
dividing the digital map into a plurality of map sections;
ascertaining input features for the plurality of map sections based on the received surroundings data sets, wherein the input features represent additional information for the plurality of map sections;
ascertaining a training data set including a plurality of training data points based on the input features, wherein each of the training data points includes a pair including a respective feature tensor assigned to a respective position of the digital map and a respective ground truth label which is a measure of correctness of a respective map section of the plurality of map sections including the respective position;
training the classifier based on the ascertained training data set to obtain a trained classifier, wherein a training step of training the classifier includes the classifier ascertaining, for each training data point, a measure of the correctness of the respective map section including the training data point based on the respective feature tensor of the training data point, wherein the ascertained measure is compared to the respective ground truth label of the training data point.

2. The method according to claim 1, wherein the respective feature tensor of the training data points is ascertained based on the input features assigned to the respective position.

3. The method according to claim 2, wherein the input features assigned to the respective position are each transformed into a fixed-length tensor to obtain the respective feature tensor.

4. The method according to claim 1, wherein the respective ground truth label is ascertained based on a comparison of the respective map section with a ground truth map of the geographic region.

5. The method according to claim 4, wherein a completeness measure is ascertained for each respective map section based on the respective map section and the ground truth map, wherein the completeness measure is a measure of the completeness of map contents of the respective map section relative to the ground truth map, wherein the respective ground truth label is ascertained based on the respective completeness measure.

6. The method according to claim 4, wherein a respective deviation from one or more positions of one or more map contents of the respective map section relative to the ground truth map is ascertained for the respective map section, wherein the respective ground truth label is ascertained based on the ascertained respective deviation or deviations.

7. The method according to claim 4, wherein a respective Jaccard index between one or more map contents of the respective map section relative to the ground truth map is ascertained for the respective map section, wherein the respective ground truth label is ascertained based on the respective ascertained Jaccard index.

8. The method according to claim 1, wherein the input features are respective elements selected from the following group of input features: a landmark of the digital map, an additional attribute for a map feature of the digital map, a number of surroundings data sets used to ascertain the digital map at a location in the geographic region, metadata including a source of a surroundings data set, an error measure which indicates a consistency of the digital map compared to the surroundings data sets used to create the digital map.

9. The method according to claim 8, wherein the landmark is an element selected from the following group of landmarks: lane marking, traffic light system, traffic sign, upright structure.

10. The method according to claim 9, wherein: (i) the additional attribute indicates what information is provided by the traffic sign, or (ii) the additional attribute indicates a type of lane marking.

11. The method according to claim 8, wherein the metadata including the source of the surroundings data set, includes one or more of the following pieces of information: (i) a type of motor vehicle, (ii) a motor vehicle speed, (iii) a surroundings sensor modality and/or surroundings sensor version of a surroundings sensor of the corresponding motor vehicle used to create the surroundings data set, (iv) a date of acquisition of the surroundings by one or more surroundings sensors of the motor vehicle used to create the surroundings data set, (v) a time of acquisition of the surroundings by one or more surroundings sensors of the motor vehicle used to create the surroundings data set, (v) weather at a time of acquisition of the surroundings by one or more surroundings sensors of the motor vehicle used to create the surroundings data set, (vi) a type including city or freeway information about the surroundings including a number of motor vehicles and/or pedestrians and/or bicyclists and/or road users.

12. The method according to claim 1, wherein the respective ground truth label and/or the measure for correctness ascertained by the classifier indicates a respective class affiliation in terms of correctness to two or more classes.

13. A method for map verification, comprising the following steps:
receiving a plurality of surroundings data sets, each of the surroundings data sets representing respective surroundings of motor vehicles during respective trips of the motor vehicles through the same geographic region;
creating a digital map of the geographic region based on the surroundings data sets;
dividing the digital map into a plurality of map sections;
ascertaining input features for the plurality of map sections based on the received surroundings data sets, wherein the input features represent additional information for the plurality of map sections;
ascertaining a feature tensor assigned to a respective position of the digital map based on the input features; and
ascertaining one or more measures for correctness of each respective map section of the digital map including a respective position based on the feature tensor using a classifier to verify the digital map.

14. The method according to claim 13, wherein a confidence of each respective map section is ascertained as a measure, wherein the confidence is compared to a threshold value, wherein, depending on the comparison, a binary truth value is ascertained as a measure which indicates whether the respective map section is correct or incorrect.

15. The method according to claim 13, wherein a variance of a confidence of the respective map section is ascertained as a measure.

16. The method according to claim 13, wherein the classifier has been trained by:
receiving a plurality of second surroundings data sets, each of the second surroundings data sets representing respective second surroundings of second motor vehicles during respective trips of the second motor vehicles through the same geographic region;
creating a second digital map of the second geographic region based on the second surroundings data sets;
dividing the second digital map into a plurality of second map sections;
ascertaining second input features for the plurality of second map sections based on the received second surroundings data sets, wherein the second input features represent additional information for the plurality of second map sections;
ascertaining a training data set including a plurality of training data points based on the second input features, wherein each of the training data points includes a pair including a respective feature tensor assigned to a respective position of the digital map and a respective ground truth label which is a measure of correctness of a respective second map section of the plurality of second map sections including the respective position; and
training the classifier based on the ascertained training data set to obtain a trained classifier, wherein a training step of training the classifier includes the classifier ascertaining, for each training data point, a measure of the correctness of the respective second map section including the training data point based on the respective feature tensor of the training data point, wherein the ascertained measure is compared to the respective ground truth label of the training data point.

17. A device configured for training a classifier for map verification, the device being configured to perform the steps comprising:
receiving a plurality of surroundings data sets, each of the surroundings data sets representing respective surroundings of motor vehicles during respective trips of the motor vehicles through the same geographic region;
creating a digital map of the geographic region based on the surroundings data sets;
dividing the digital map into a plurality of map sections;
ascertaining input features for the plurality of map sections based on the received surroundings data sets, wherein the input features represent additional information for the plurality of map sections;
ascertaining a training data set including a plurality of training data points based on the input features, wherein each of the training data points includes a pair including a respective feature tensor assigned to a respective position of the digital map and a respective ground truth label which is a measure of correctness of a respective map section of the plurality of map sections including the respective position;
training the classifier based on the ascertained training data set to obtain a trained classifier, wherein a training step of training the classifier includes the classifier ascertaining, for each training data point, a measure of the correctness of the respective map section including the training data point based on the respective feature tensor of the training data point, wherein the ascertained measure is compared to the respective ground truth label of the training data point.

18. A non-transitory machine-readable storage medium on which is stored a computer program for training a classifier for map verification, the computer program, when executed by a computer, causing the computer to perform the following steps comprising:
receiving a plurality of surroundings data sets, each of the surroundings data sets representing respective surroundings of motor vehicles during respective trips of the motor vehicles through the same geographic region;
creating a digital map of the geographic region based on the surroundings data sets;
dividing the digital map into a plurality of map sections;
ascertaining input features for the plurality of map sections based on the received surroundings data sets, wherein the input features represent additional information for the plurality of map sections;
ascertaining a training data set including a plurality of training data points based on the input features, wherein each of the training data points includes a pair including a respective feature tensor assigned to a respective position of the digital map and a respective ground truth label which is a measure of correctness of a respective map section of the plurality of map sections including the respective position;
training the classifier based on the ascertained training data set to obtain a trained classifier, wherein a training step of training the classifier includes the classifier ascertaining, for each training data point, a measure of the correctness of the respective map section including the training data point based on the respective feature tensor of the training data point, wherein the ascertained measure is compared to the respective ground truth label of the training data point.
